(19) United States
(12) Patent Application Publication
(10) Pub. No.: US 2006/0206935 A1
(43) Pub. Date: Sep. 14, 2006

(54) Apparatus and method for adaptively preventing attacks

(76) Inventors: Byeong Cheol Choi, Daejeon-city (KR); Dong Il Seo, Daejeon-city (KR); Jong Soo Jang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/187,758

(22) Filed: Jul. 22, 2005

(30) Foreign Application Priority Data
Mar. 10, 2005 (KR) 10-2005-0020034

(51) Int. Cl. G06F 12/14

(52) U.S. Cl. 726/22

(57) ABSTRACT

An apparatus and method for adaptively preventing attacks which can reduce false positives and negatives for abnormal traffic and can adaptively deal with unknown attacks are provided. The apparatus includes: a behavior analysis unit which estimates an attack detection critical value by analyzing the behavior of network traffic; a traffic determination unit which determines what type of traffic the network traffic is using the estimated attack detection critical value; an attack determination unit which determines whether the network traffic is abnormal by analyzing the network traffic according to a set of determination rules; and an adaptive attack prevention unit which handles the network traffic based on the determination results provided by the attack determination unit. Accordingly, it is possible to reduce false positives and negatives for abnormal traffic or unknown attacks input to a network.

### CROSS-REFERENCE TO RELATED PATENT APPLICATION

This application claims the benefit of Korean Patent Application No. 10-2005-0020034, filed on Mar. 10, 2005, in the Korean Intellectual Property Office, the disclosure of which is incorporated herein in its entirety by reference.

### BACKGROUND OF THE INVENTION

1. Field of the Invention

The present invention relates to a network, and more particularly, to an apparatus and method for adaptively preventing attacks, which can reduce false positives and negatives and can be well prepared to deal with unknown attacks by determining whether traffic input to a network is normal or abnormal using an attack detection critical value and a set of determination rules obtained through behavior-based adaptive attack analysis.

2. Description of the Related Art

Conventional attack detection or prevention systems use signature-based determination rules. Even though some conventional attack detection or prevention systems are capable of detecting attacks through the behavioral analysis of network traffic, these attack detection or prevention systems still suffer from the problem of high false positives and negatives for the detection of abnormal traffic and cannot adaptively deal with unknown attacks, such as Super Worms, which are attacks launched upon a network via well-known service ports, and ‘zero-day’ attacks, which are attacks launched upon a network before the patching of computer systems connected to the network is complete.

### SUMMARY OF THE INVENTION

The present invention provides an apparatus for adaptively preventing attacks, which can prevent attacks while reducing false positives and negatives by detecting abnormal traffic or unknown attack traffic input to a network using an attack detection critical value obtained through a behavior-based adaptive attack analysis.

The present invention also provides a method of adaptively preventing attacks, which can prevent attacks while reducing false positives and negatives by detecting abnormal traffic or unknown attack traffic input to a network using an attack detection critical value obtained through a behavior-based adaptive attack analysis.

According to an aspect of the present invention, there is provided an apparatus for adaptively preventing attacks. The apparatus includes: a behavior analysis unit which estimates an attack detection critical value by analyzing the behavior of network traffic; a traffic determination unit which determines what type of traffic the network traffic is using the estimated attack detection critical value; an attack determination unit which determines whether the network traffic is abnormal by analyzing the network traffic according to a set of determination rules; and an adaptive attack prevention unit which handles the network traffic based on the determination results provided by the attack determination unit.

The determination rules may include a graylist, a whitelist, and a blacklist. The graylist may include a set of rules used to determine whether the network traffic is abnormal. The whitelist may include information regarding secure systems, nodes, or users. The blacklist may include information regarding less secure systems, nodes, or users.

The apparatus may also include a security policy management unit which automatically generates a behavioral profile of a normal user, and a graylist, a whitelist, and a blacklist related to abnormal traffic and manages the behavioral profile of the normal user, and the graylist, the whitelist, and the blacklist by storing them in a threats global information base. Here, the security policy management unit may provide the graylist, the whitelist, and the blacklist related to the abnormal traffic to the attack determination unit.

The adaptive attack prevention unit may allow transmission of the network traffic, block the network traffic, or control the network traffic according to whether the network traffic is abnormal.

According to another aspect of the present invention, there is provided a method of adaptively preventing attacks. The method includes: estimating an attack detection critical value by analyzing the behavior of network traffic; determining what type of traffic the network traffic is using the estimated attack detection critical value; determining whether the network traffic is abnormal by analyzing the network traffic according to a set of determination rules; and adaptively allowing transmission of the network traffic, blocking the network traffic, or controlling the network traffic based on the determination results.

The determination rules may include a graylist, a whitelist, and a blacklist. The graylist may include a set of rules used to determine whether the network traffic is abnormal. The whitelist may include information regarding secure systems, nodes, or users. The blacklist may include information regarding less secure systems, nodes, or users.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of an apparatus for adaptively preventing attacks according to an exemplary embodiment of the present invention;

FIG. 2 is a block diagram of an apparatus for adaptively preventing attacks according to an exemplary embodiment of the present invention;

FIG. 3 is a flowchart illustrating a method of adaptively preventing attacks according to an exemplary embodiment of the present invention;

FIG. 4 is a graph of the probability of network traffic being normal and abnormal according to an attack detection critical value used in behavior-based adaptive attack determination; and

FIG. 5 is a block diagram explaining an adaptive classification method according to an exemplary embodiment of the present invention.

### DETAILED DESCRIPTION OF THE INVENTION

The present invention will now be described more fully with reference to the accompanying drawings in which exemplary embodiments of the invention are shown. Terms used in this disclosure have been defined in consideration of their functions in this disclosure and may have different meanings depending on a user's intent or understanding. Therefore, the terms are defined based on the invention claimed in this disclosure.

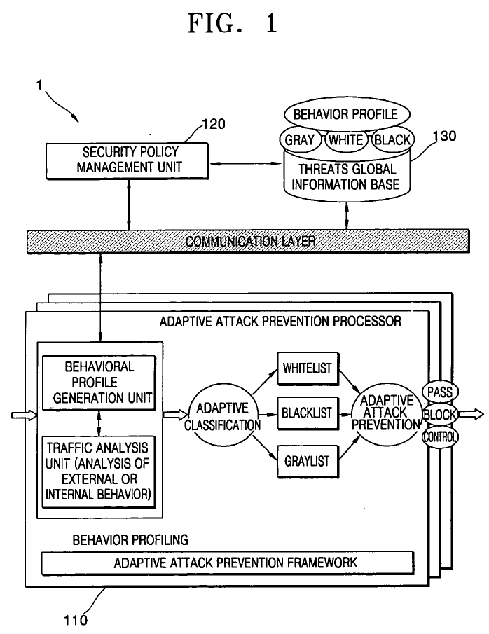

FIG. 1 is a schematic diagram of an apparatus 1 for adaptively preventing attacks according to an exemplary embodiment of the present invention. Referring to FIG. 1, the apparatus 1 uses behavior-based adaptive attack analysis and performs an attack control using a graylist, a whitelist, and a blacklist.

The apparatus 1 includes an adaptive attack prevention processor 110 and a security policy management unit 120.

The adaptive attack prevention processor 110 generates a behavioral profile by analyzing network traffic; classifies the network traffic; adaptively applies an attack detection critical value to the network traffic; establishes adaptive countermeasures against attacks by using a set of determination rules, including a graylist, a whitelist, a blacklist, and a decision-by-majority rule; and allows transmission of the network traffic, blocks the network traffic, or controls the network traffic using rate limitations.

The security policy management unit 120 automatically generates a behavioral profile, a graylist, which includes a set of rules used to determine whether network traffic is abnormal, a whitelist, which includes information regarding secure systems/nodes/users, and a blacklist, which includes information regarding less secure systems/nodes/users, and manages the behavioral profile, the graylist, the whitelist, and the blacklist by storing them in a threats global information base (TGIB) 130.

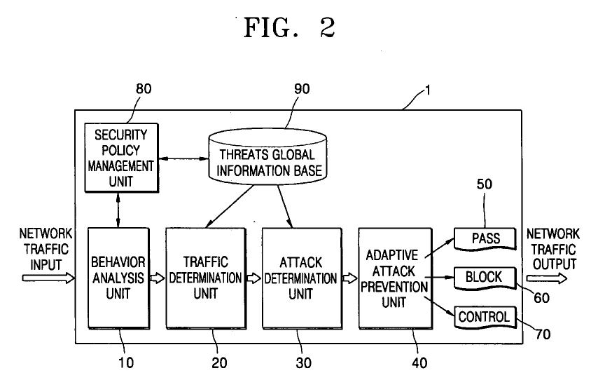

FIG. 2 is a block diagram of an apparatus 1 for adaptively preventing attacks according to an exemplary embodiment of the present invention. Referring to FIG. 2, the apparatus 1 includes a behavior analysis unit 10, a traffic determination unit 20, an attack determination unit 30, an adaptive attack prevention unit 40, a security policy management unit 80, and a TGIB 90.

The behavior analysis unit 10 estimates an attack detection critical value by analyzing the behavior of network traffic. The traffic determination unit 20 determines what type of traffic the network traffic is based on the estimated attack detection critical value.

The attack determination unit 30 determines whether the network traffic is abnormal by analyzing the network traffic according to a set of determination rules. The determination rules include a graylist, a whitelist, and a blacklist. The graylist includes a set of rules used to determine whether network traffic is abnormal, the whitelist includes information regarding secure systems/nodes/users, and the blacklist includes information regarding less secure systems/nodes/users.

The adaptive attack prevention unit 40 adaptively deals with the network traffic based on the determination results provided by the attack determination unit 30. For example, the adaptive attack prevention unit 40 may decide to allow transmission (50) of the network traffic, block (60) the network traffic, or control (70) the network traffic using rate limitations based on the determination results provided by the attack determination unit 30.

The security policy management unit 80 manages rule information by storing it in the TGIB 90. The rule information includes a behavioral profile of a normal user, and a graylist, a whitelist, and a blacklist related to abnormal traffic. The security policy management unit 80 may automatically generate and manage the rule information. In addition, the security policy management unit 80 provides the rule information to the attack determination unit 30 so that the attack determination unit 30 can determine what type of traffic the network traffic is by using the gray, white, and blacklists related to the abnormal traffic included in the rule information.

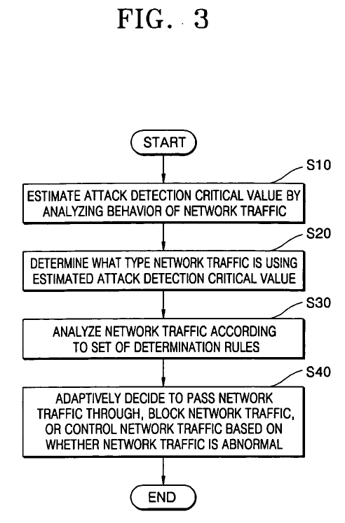

FIG. 3 is a flowchart illustrating a method of adaptively preventing attacks according to an exemplary embodiment of the present invention. Referring to FIG. 3, in operation S10, an attack detection critical value is estimated by analyzing the behavior of network traffic. In operation S20, it is determined what type of traffic the network traffic is using the estimated attack detection critical value. In operation S30, it is determined whether the network traffic is abnormal by analyzing the network traffic according to a set of determination rules.

The determination rules include a graylist, a whitelist, and a blacklist. The graylist includes a set of rules used to determine whether network traffic is abnormal, the whitelist includes information regarding secure systems/nodes/users, and the blacklist includes information regarding less secure systems/nodes/users.

In operation S40, it is determined whether to allow transmission of the network traffic, block the network traffic, or control the network traffic using rate limitations depending on the analysis results obtained in operation S30 indicating whether the network traffic is abnormal.

In the present embodiment, it is determined whether to pass the network traffic through, block the network traffic, or control the network traffic using rate limitations by processing the network using a graylist, a whitelist, and a blacklist in parallel and applying a decision by a majority rule. Thus, it is possible to prevent attacks while reducing false network attack alarm rates. In addition, it is possible to prevent unknown attacks, such as Super Worms and ‘zero-day’ attacks, by adaptively detecting, analyzing, and dealing with the unknown attacks.

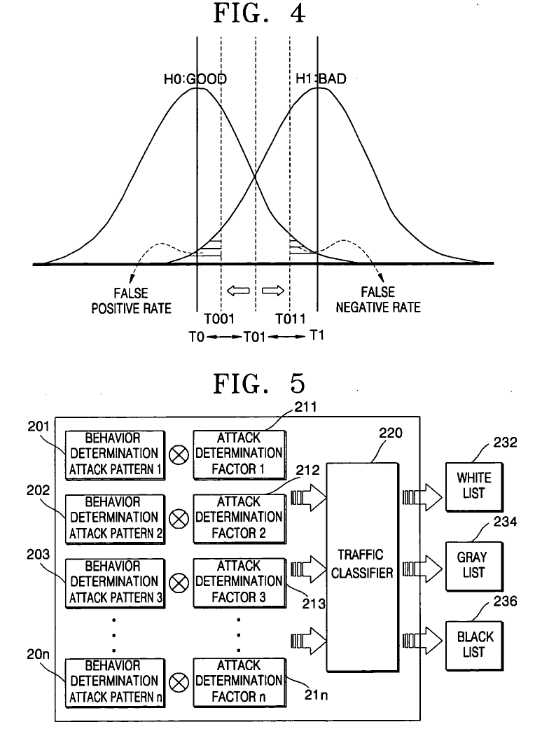

FIG. 4 is a graph of the probability of network traffic being normal and abnormal according to an attack detection critical value used in behavior-based adaptive attack determination. Referring to FIG. 4, the attack detection critical value is appropriately adaptively adjusted so that the occurrence of false positives and false negatives is reduced. In other words, it is possible to minimize false positives and negatives by using the apparatus and method for adaptively preventing attacks according to exemplary embodiments of the present invention.

In detail, when estimating the attack detection critical value by analyzing the behavior of network traffic in the apparatus for adaptively preventing attacks according to an exemplary embodiment of the present invention, the attack detection critical value, which is initially T01 as a result of binary hypothesis testing, is adaptively moved to T001 or T011, in which case, the occurrence of false positives and false negatives decreases. Here, a false positive occurs when normal network traffic is identified as abnormal attack traffic, and a false negative occurs when abnormal attack traffic is identified as normal network traffic.

FIG. 5 is a block diagram explaining an adaptive classification method according to an exemplary embodiment of the present invention. Specifically, FIG. 5 illustrates an adaptive classification module inside the adaptive attack prevention processor 110 of FIG. 1, the traffic determination unit 20 and the attack determination unit 30 of FIG. 2, and the method of adaptively preventing attacks as illustrated in FIG. 3 in further detail. Referring to FIG. 5, modules 201, 202, 203, . . . , 20n extract behavior determination attack patterns 1 through n from network traffic, and the extracted behavior determination attack patterns 1 through n are multiplied by attack determination factors 1 through n, (211 through 21n), respectively. Thereafter, a traffic classifier 220 classifies the network traffic based on the multiplied results and then stores the network traffic in one of a whitelist 232, a graylist 234, and a blacklist 246 so that the network traffic is adaptively handled.

In the present invention, an adaptive attack prevention technique capable of minimizing false positives and negatives by setting an adaptive attack detection critical value through the behavioral profiling of a harmful traffic is provided. Thus, it is possible to maximize the efficiency of determining whether network traffic is normal or abnormal.

The apparatus for adaptively preventing attacks according to the present invention realizes an adaptive attack prevention technique for setting an adaptive attack detection critical value by adaptively analyzing, detecting, and handling network traffic based on the behavioral profile and characteristics of the network traffic. Thus, the apparatus for adaptively preventing attacks according to the present invention can efficiently detect and deal with attacks even in an environment where it is extremely difficult to determine whether traffic currently input to a network are normal or abnormal.

In addition, according to the present invention, it is possible to maximize the efficiency of determining whether network traffic is normal or abnormal and reduce false positives and negatives.

The present invention can be realized as computer-readable code written on a computer-readable recording medium. The computer-readable recording medium may be any type of recording device-in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that a computer-readable code is written thereto and executed therefrom in a decentralized manner. Functional programs, code, and code segments needed for realizing the present invention can be easily deduced by one of ordinary skill in the art.

As described above, it is possible to reduce false positives and negatives for abnormal traffic or unknown attack traffic input to a network.

In addition, it is possible to adaptively detect, analyze, and deal with unknown attacks, such as Super Worms or ‘zero day’ attacks.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for adaptively preventing attacks comprising:
a behavior analysis unit which estimates an attack detection critical value by analyzing the behavior of network traffic;
a traffic determination unit which determines what type of traffic the network traffic is using the estimated attack detection critical value;
an attack determination unit which determines whether the network traffic is abnormal by analyzing the network traffic according to a set of determination rules; and
an adaptive attack prevention unit which handles the network traffic based on the determination results provided by the attack determination unit.

2. The apparatus of claim 1, wherein the determination rules comprise a graylist, a whitelist, and a blacklist; the graylist comprises a set of rules used to determine whether the network traffic is abnormal; the whitelist comprises information regarding secure systems, nodes, or users; and the blacklist comprises information regarding less secure systems, nodes, or users.

3. The apparatus of claim 2 further comprising a security policy management unit which automatically generates a behavioral profile of a normal user, and a graylist, a whitelist, and a blacklist related to abnormal traffic and manages the behavioral profile of the normal user, and the graylist, the whitelist, and the blacklist by storing them in a threats global information base,
wherein the security policy management unit provides the graylist, the whitelist, and the blacklist related to the abnormal traffic to the attack determination unit.

4. The apparatus of claim 1, wherein the adaptive attack prevention unit allows transmission of the network traffic, blocks the network traffic, or controls the network traffic according to whether the network traffic is abnormal.

5. A method of adaptively preventing attacks comprising:
estimating an attack detection critical value by analyzing the behavior of network traffic;
determining what type of traffic the network traffic is using the estimated attack detection critical value;
determining whether the network traffic is abnormal by analyzing the network traffic according to a set of determination rules; and
adaptively allowing transmission of the network traffic, blocking the network traffic, or controlling the network traffic based on the determination results.

6. The method of claim 5, wherein the determination rules comprise a graylist, a whitelist, and a blacklist; the graylist comprises a set of rules used to determine whether the network traffic is abnormal; the whitelist comprises information regarding secure systems, nodes, or users; and the blacklist comprises information regarding less secure systems, nodes, or users.

7. A computer-readable recording medium storing a computer program is 5 for executing the method of claim 5 or 6.
